(19) United States
(12) Patent Application Publication
(10) Pub. No.: US 2025/0202116 A1
(43) Pub. Date: Jun. 19, 2025

(54) ANTENNA STRUCTURE AND ELECTRONIC DEVICE

(71) Applicant: VIVO MOBILE COMMUNICATION CO., LTD., Dongguan (CN)

(72) Inventor: Bo SONG, Dongguan (CN)

(73) Assignee: VIVO MOBILE COMMUNICATION CO., LTD., Dongguan (CN)

(21) Appl. No.: 19/070,471

(22) Filed: Mar. 4, 2025

Related U.S. Application Data
(63) Continuation of application No. PCT/CN2023/115625, filed on Aug. 30, 2023.

(30) Foreign Application Priority Data
Sep. 5, 2022 (CN) 202211078696.0

(51) Int. Cl. H01Q 5/50; H01Q 1/24; H01Q 5/378

(52) U.S. Cl. CPC H01Q 5/50; H01Q 5/378; H01Q 1/243

(57) ABSTRACT

This application discloses an antenna structure and an electronic device. The antenna structure includes an antenna radiation body, a first coupled radiation branch, a second coupled radiation branch, a first feed, a first matching circuit, and a second matching circuit. The antenna radiation body is located between the first coupled radiation branch and the second coupled radiation branch, there is a gap between the antenna radiation body and the first coupled radiation branch, and there is a gap between the antenna radiation body and the second coupled radiation branch. The first feed is disposed between a first feed point on the antenna radiation body and a ground plane. The first matching circuit is disposed between a first position of the antenna radiation body and a ground plane. The second matching circuit is disposed between a second position of the antenna radiation body and a ground plane.

### CROSS-REFERENCE TO RELATED APPLICATIONS

This application is a continuation of International Application No. PCT/CN2023/115625, filed Aug. 30, 2023, which claims priority to Chinese Patent Application No. 202211078696.0, filed Sep. 5, 2022. The entire contents of each of the above-referenced applications are expressly incorporated herein by reference.

### TECHNICAL FIELD

This application pertains to the field of communications technologies, and specifically relates to an antenna structure and an electronic device.

### BACKGROUND

Antennas in existing electronic devices, such as Global Positioning System (GPS) antennas, typically operate in a single-mode manner, resulting in a simple operating mode. In addition, to cause operating currents to quickly return to the ground, wide-sized metals are typically used in existing GPS antennas for a connection between antenna radiation bodies and the main ground. Operating currents of the GPS antennas of this type are usually concentrated in a small area, resulting in less excited transverse currents and poor radiation performance of the antennas. It is clear that the antennas in existing electronic devices suffer from a single operating mode and poor radiation performance.

### SUMMARY

Embodiments of this application aim to provide an antenna structure and an electronic device.

According to a first aspect, an embodiment of this application provides an antenna structure, including:

an antenna radiation body, a first coupled radiation branch, a second coupled radiation branch, a first feed, a first matching circuit, and a second matching circuit.

The antenna radiation body is located between the first coupled radiation branch and the second coupled radiation branch, there is a gap between the antenna radiation body and the first coupled radiation branch, and there is a gap between the antenna radiation body and the second coupled radiation branch.

The first feed is disposed between a first feed point on the antenna radiation body and a ground plane.

The first matching circuit is disposed between a first position of the antenna radiation body and a ground plane.

The second matching circuit is disposed between a second position of the antenna radiation body and a ground plane.

A third position of the second coupled radiation branch is grounded, where
the first matching circuit includes a first capacitor, the second matching circuit includes a second capacitor, a distance between the first position and the first feed point is less than a distance between the second position and the first feed point, and a capacitance value of the first capacitor is greater than a capacitance value of the second capacitor.

According to a second aspect, an embodiment of this application provides an electronic device, including the antenna structure according to the first aspect.

In this embodiment of this application, the antenna structure includes an antenna radiation body, a first coupled radiation branch, a second coupled radiation branch, a first feed, a first matching circuit, and a second matching circuit. The antenna radiation body is located between the first coupled radiation branch and the second coupled radiation branch, there is a gap between the antenna radiation body and the first coupled radiation branch, and there is a gap between the antenna radiation body and the second coupled radiation branch. The first feed is disposed between a first feed point on the antenna radiation body and a ground plane. The first matching circuit is disposed between a first position of the antenna radiation body and a ground plane. The second matching circuit is disposed between a second position of the antenna radiation body and a ground plane. A third position of the second coupled radiation branch is grounded. The first matching circuit includes a first capacitor, the second matching circuit includes a second capacitor, a distance between the first position and the first feed point is less than a distance between the second position and the first feed point, and a capacitance value of the first capacitor is greater than a capacitance value of the second capacitor. In this way, a plurality of feed branches are designed in the antenna structure, so that an antenna can form a plurality of current loops to support a plurality of operating modes, and an operating current of the antenna can excite a stronger transverse current, thereby improving radiation performance of the antenna.

### BRIEF DESCRIPTION OF DRAWINGS

FIG. 1 is a first schematic diagram of an antenna structure according to an embodiment of this application;

FIG. 2 is a schematic diagram of an existing antenna structure;

FIG. 3 is a schematic diagram of an operating current mode and an excited transverse current of an existing antenna structure;

FIG. 4 is a schematic diagram of an operating current mode and an excited transverse current of the antenna structure shown in FIG. 1 according to an embodiment of this application;

FIG. 5 is a second schematic diagram of an antenna structure according to an embodiment of this application;

FIG. 6 is a schematic comparison diagram of radiation efficiency generated by an existing antenna structure and by the antenna structure shown in FIG. 1 according to an embodiment of this application;

FIG. 7 is a schematic diagram of angles of an electronic device in a rectangular coordinate system according to an embodiment of this application;

FIG. 8a is a schematic comparison diagram of radiation patterns of an existing antenna structure and an antenna structure according to an embodiment of this application in a polar coordinate system when Phi=0°;

FIG. 8b is a schematic comparison diagram of radiation patterns of an existing antenna structure and an antenna structure according to an embodiment of this application in a polar coordinate system when Phi=90°;

FIG. 9 is a third schematic diagram of an antenna structure according to an embodiment of this application;

FIG. 10a is a schematic diagram of an operating current mode and an excited transverse current of the antenna structure shown in FIG. 9 according to an embodiment of this application;

FIG. 10b is a schematic diagram of an operating current mode of the antenna structure shown in FIG. 9 according to an embodiment of this application;

FIG. 11 is a schematic diagram of a structure of a matching circuit according to an embodiment of this application;

FIG. 12 is a fourth schematic diagram of an antenna structure according to an embodiment of this application;

FIG. 13a is a schematic diagram of an operating current mode and an excited transverse current of the antenna structure shown in FIG. 12 according to an embodiment of this application;

FIG. 13b is a first schematic diagram of an operating current mode of the antenna structure shown in FIG. 12 according to an embodiment of this application;

FIG. 13c is a second schematic diagram of an operating current mode of the antenna structure shown in FIG. 12 according to an embodiment of this application; and

FIG. 14 is a schematic diagram of a structure of a parasitic branch switch circuit according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In this specification and claims of this application, the terms such as “first” and “second” are used for distinguishing similar objects, and are not necessarily used to describe a particular order or sequence. It should be understood that terms used in such a way are interchangeable in proper circumstances, so that embodiments of this application can be implemented in an order other than the order illustrated or described herein. Objects classified by “first”, “second”, and the like are usually of a same type, and a quantity of objects is not limited. For example, there may be one or more first objects. In addition, in this specification and the claims, “and/or” indicates at least one of connected objects, and a character “/” generally indicates an “or” relationship between associated objects.

An antenna structure provided in an embodiment of this application will be described in detail below through specific embodiments and application scenarios with reference to the accompanying drawings.

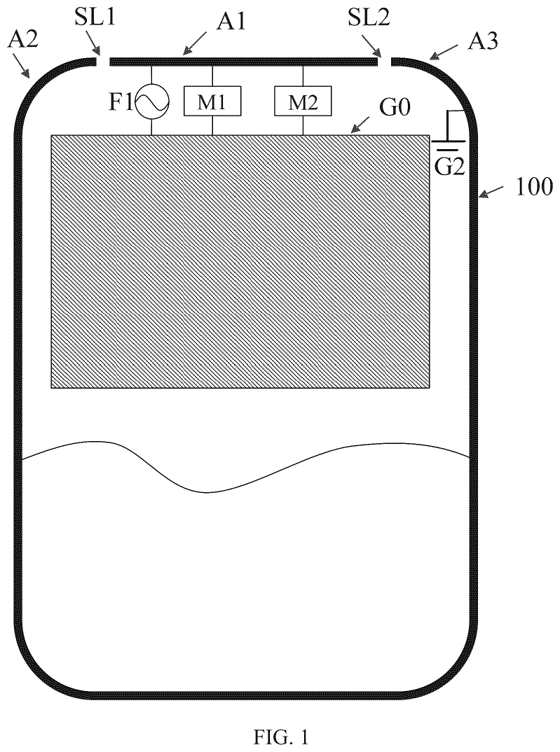

FIG. 1 is a schematic diagram of a structure of an antenna structure according to an embodiment of this application. As shown in FIG. 1, the antenna structure includes: an antenna radiation body A1, a first coupled radiation branch A2, a second coupled radiation branch A3, a first feed F1, a first matching circuit M1, and a second matching circuit M2.

The antenna radiation body A1 is located between the first coupled radiation branch A2 and the second coupled radiation branch A3, there is a gap between the antenna radiation body A1 and the first coupled radiation branch A2, and there is a gap between the antenna radiation body A1 and the second coupled radiation branch A3.

The first feed F1 is disposed between a first feed point on the antenna radiation body A1 and a ground plane.

The first matching circuit M1 is disposed between a first position of the antenna radiation body A1 and a ground plane.

The second matching circuit M2 is disposed between a second position of the antenna radiation body A1 and a ground plane.

A third position of the second coupled radiation branch A3 is grounded, where the first matching circuit M1 includes a first capacitor C1, the second matching circuit M2 includes a second capacitor C2, a distance between the first position and the first feed point is less than a distance between the second position and the first feed point, and a capacitance value of the first capacitor C1 is greater than a capacitance value of the second capacitor C2.

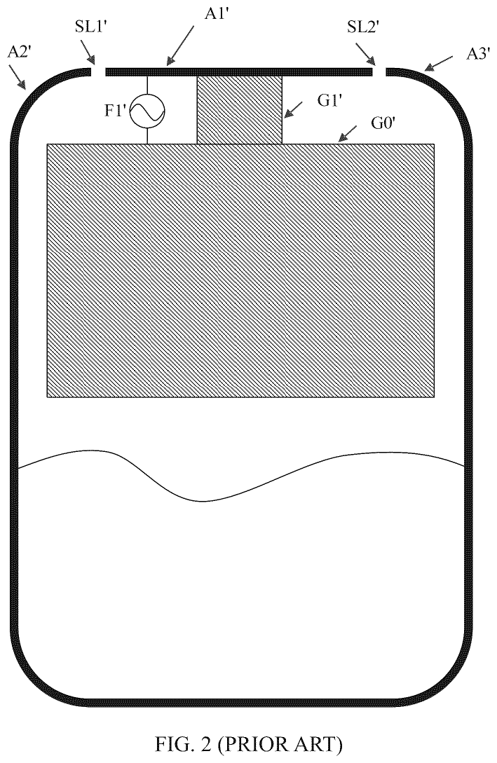

In this embodiment of this application, to improve radiation performance of a GPS antenna, an enhanced GPS antenna structure shown in FIG. 1 is proposed. The antenna structure is different from an existing antenna structure shown in FIG. 2. To be specific, instead of adopting a manner of connecting to main ground through a wide-sized metal to bring an operating current back to ground completely as soon as possible, a plurality of down-ground circuits are disposed between an antenna radiator and the main ground to generate a plurality of current loops, so as to enable the antenna structure to support a plurality of operating modes. In contrast, the antenna structure shown in FIG. 2 can only support a single Inverted-F Antenna (IFA) ¼ wavelength mode. The antenna structure in this embodiment of this application can support at least three operating modes, increase an antenna equivalent diameter, and apply a current mode with a stronger radiation capability, thereby improving radiation performance of the GPS antenna.

As shown in FIG. 1, the antenna structure 100 in this embodiment of this application includes the antenna radiation body A1, the first coupled radiation branch A2, the second coupled radiation branch A3, the first feed F1, the first matching circuit M1, and the second matching circuit M2. The antenna structure 100 may be disposed on a top of an electronic device and used as an enhanced GPS antenna system to improve radiation performance of a GPS antenna in the electronic device.

The first coupled radiation branch A2 and the second coupled radiation branch A3 are respectively disposed on left and right sides of the antenna radiation body A1, there is a first coupling gap SL1 between the antenna radiation body A1 and the first coupled radiation branch A2, and there is a second coupling gap SL2 between the antenna radiation body A1 and the second coupled radiation branch A3. The coupling gaps each may be embodied as a frame gap in a metal frame of the electronic device. The antenna radiation body A1, the first coupled radiation branch A2, and the second coupled radiation branch A3 may have a metal outer frame, or may be made by using an antenna technology such as Laser Direct Structuring (LDS) or Flexible Printed Circuit (FPC).

The first feed F1 is disposed between the first feed point on the antenna radiation body A1 and the ground plane. To be specific, one end of the first feed F1 may be connected to the first feed point on the antenna radiation body A1, and the other end of the first feed F1 may be grounded, for example, may be connected to main ground G0 in the electronic device.

The first matching circuit M1 is disposed between the first position of the antenna radiation body A1 close to the first feed point and the ground plane. To be specific, one end of the first matching circuit M1 may be connected to the first position of the antenna radiation body A1, and the other end of the first matching circuit M1 may be grounded, for example, may be connected to the main ground G0 in the electronic device.

The second matching circuit M2 is disposed between the second position of the antenna radiation body A1 away from the first feed point and the ground plane. To be specific, one end of the second matching circuit M2 may be connected to the second position of the antenna radiation body A1, and the other end of the second matching circuit M2 may be grounded, for example, may be connected to the main ground G0 in the electronic device.

The main ground G0 may be a metal plate with a large area, or may be a Printed Circuit Board (PCB) in the electronic device.

The third position of the second coupled radiation branch A3 is grounded, for example, the third position of the second coupled radiation branch A3 may be connected to a ground point G2.

In this embodiment of this application, the first matching circuit M1 includes the first capacitor C1, and the second matching circuit M2 includes the second capacitor C2. In some embodiments, the first matching circuit M1 may further include another component, such as a capacitor or a resistor, and the second matching circuit M2 may further include another component, such as a capacitor, an inductor, a resistor, and a power supply. The first capacitor C1 and the second capacitor C2 are two key current-through capacitors in the antenna structure 100. The first capacitor C1 close to the first feed point is required to be a large capacitor, and the second capacitor C2 away from the first feed point is required to be a small capacitor. For example, the first capacitor C1 is 33 pf, and the second capacitor C2 is 3 pf. In this way, the first matching circuit M1 and the second matching circuit M2 have different ground paths, so that the antenna structure 100 can support different operating bands and operating current modes.

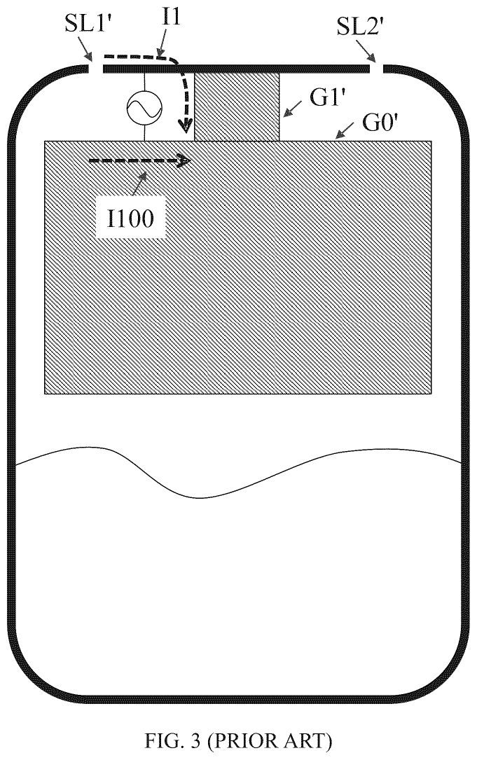

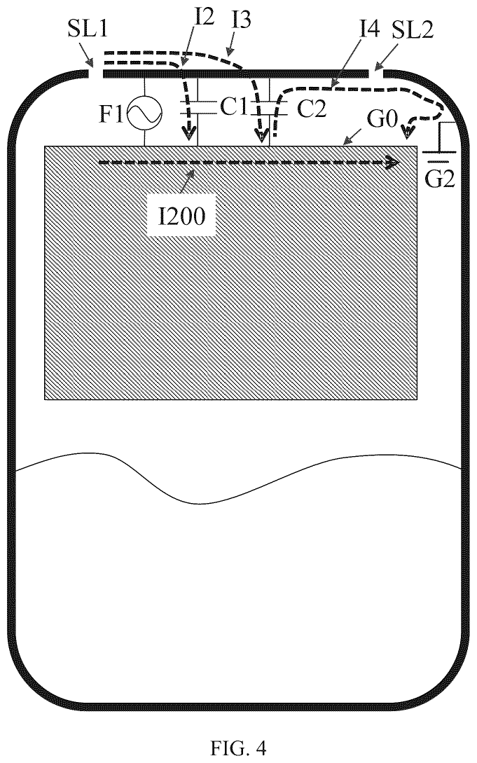

An operating current mode of an existing conventional GPS antenna system, as indicated by I1 in FIG. 3, utilizes an IFA ¼ wavelength mode I1 from G1′ to SL1′. However, as shown in FIG. 4, an operating current mode of an enhanced GPS antenna structure designed in this embodiment of this application can support three operating current modes 12, 13, and I4, where I2 is an IFA ¼ wavelength mode 12 from SL1 to the first matching circuit M1, 13 is a loaded IFA ¼ wavelength mode from SL1 to M2, and I4 is a gap co-directional current mode from G2 through SL2 to M2 (that is, currents on two sides of the second coupling gap SL2 are co-directional). In other words, the operating mode of the antenna structure 100 in this embodiment of this application is a common mode of 12, 13, and I4, where I4 is a mode with higher radiation performance, and I2, I3, and I4 jointly improve radiation aperture and radiation performance of the antenna structure 100.

In addition, a range of transverse currents excited by the conventional GPS antenna scheme shown in FIG. 2 is indicated by 1100 in FIG. 3. Operating currents of the conventional GPS antenna are usually concentrated in a small area at the top, resulting in less excited transverse currents at the top, and a lower proportion of an upper hemisphere in an antenna radiation pattern. A range of transverse currents excited by the antenna design scheme in this embodiment of this application is indicated by 1200 in FIG. 4. In this antenna design scheme, a range of operating currents is expanded, so that a stronger transverse current mode is excited, thereby improving a radiation capability of the upper hemisphere of the antenna. In addition, a higher radiation proportion of the upper hemisphere of the GPS antenna in the electronic device can significantly improve user experience.

It should be noted that, in this embodiment of this application, the antenna structure 100 may be used as a proximity sensor (SAR) detection apparatus because the antenna radiator is not connected to the main ground by using a metal block, so that the entire top antenna is in a suspended state.

In some embodiments, one end of the first capacitor C1 is connected to the first position, and the other end of the first capacitor C1 is grounded to form the first matching circuit M1.

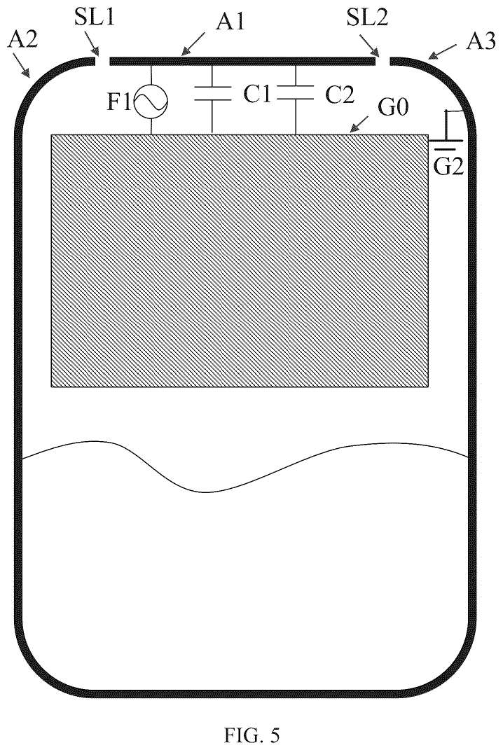

In an implementation, as shown in FIG. 5, the first matching circuit M1 may include only the first capacitor C1. In this case, the first capacitor C1 is used as a current-through capacitor in the antenna structure 100 to generate a current loop, so that the antenna structure 100 can operate in the IFA ¼ wavelength mode 12 from SL1 to C1 shown in FIG. 4. In this implementation, it is ensured that the antenna structure 100 is simple and easy to implement.

In some embodiments, one end of the second capacitor C2 is connected to the second position, and the other end of the second capacitor C2 is grounded to form the second matching circuit M2.

In an implementation, as shown in FIG. 5, the second matching circuit M2 may include only the second capacitor C2. In this case, the second capacitor C2 is used as another current-through capacitor in the antenna structure 100 to generate a current loop, so that the antenna structure 100 can operate in the loaded IFA ¼ wavelength mode I3 from SL1 to C2 shown in FIG. 4. In this implementation, it is ensured that the antenna structure 100 is simple and easy to implement.

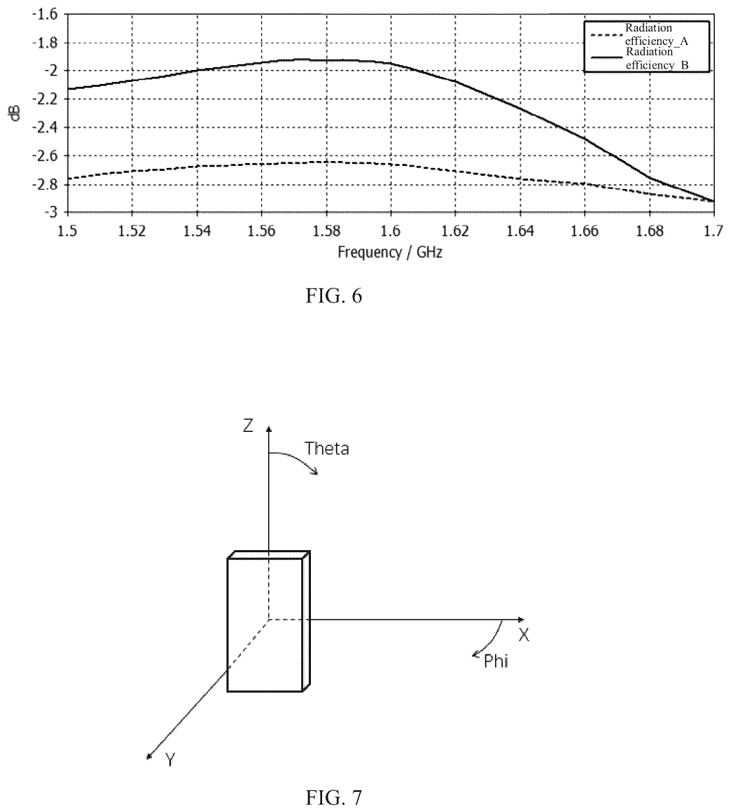

For radiation efficiency comparison between the antenna structure 100 in this embodiment of this application and the conventional GPS antenna system shown in FIG. 2, refer to FIG. 6. Radiation efficiency_A is the radiation efficiency of the conventional GPS antenna system, and radiation efficiency_B is the radiation efficiency of the antenna structure 100 in this embodiment of this application. It can be learned that in this embodiment of this application, radiation efficiency of a GPS band can be improved by approximately 0.8 dB by using the operating mode with a stronger radiation capability and a larger aperture.

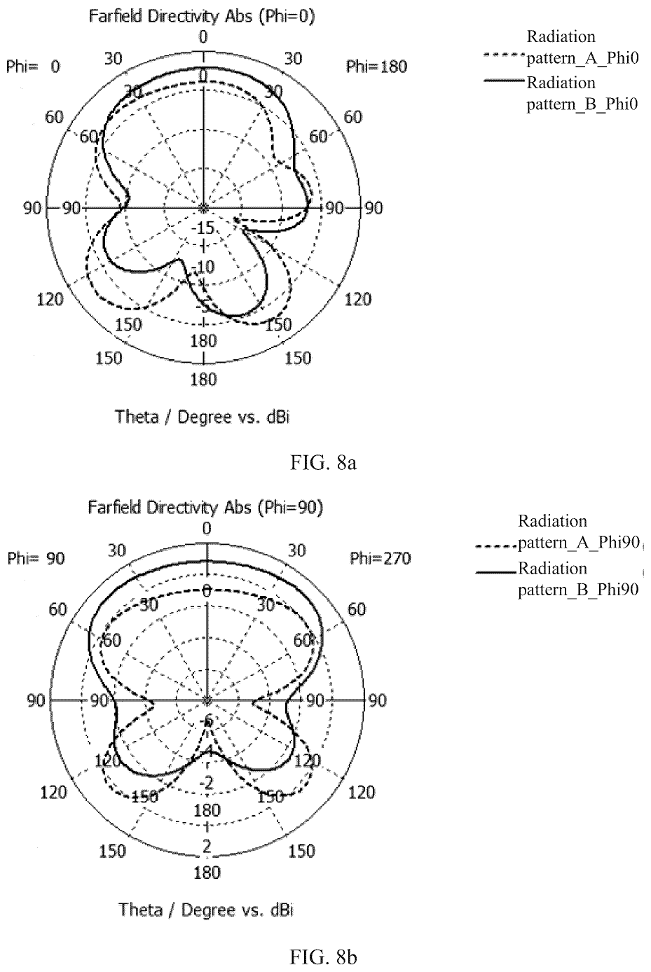

To describe the radiation proportion of the upper hemisphere of the antenna structure 100 in this embodiment of this application, refer to FIG. 7, FIG. 8a, and FIG. 8b. FIG. 7 is a diagram of angles of an electronic device in a rectangular coordinate system, in which a center cube is an electronic device 700, with Phi representing an azimuth angle, and Theta representing a pitch angle. The radiation proportion of the upper hemisphere of the antenna is examined by examining radiation proportions within the ranges of Phi from 0° to 360° and Theta from 0° to 90°.

FIG. 8a and FIG. 8b are respectively schematic comparison diagrams of radiation patterns in a polar coordinate system when Phi=0° and Phi=90°, where a radiation pattern_A is a radiation pattern of the conventional GPS antenna scheme shown in FIG. 2, and a radiation pattern_B is a radiation pattern of the antenna structure 100 in this embodiment of this application. It can be learned from the figures that the radiation proportion of the upper hemisphere of the antenna scheme in this embodiment of this application is significantly higher than that of the conventional antenna scheme. The radiation proportion of the upper hemisphere of the antenna scheme in this embodiment of this application can be increased from 55% to 65% compared to that of the conventional antenna scheme.

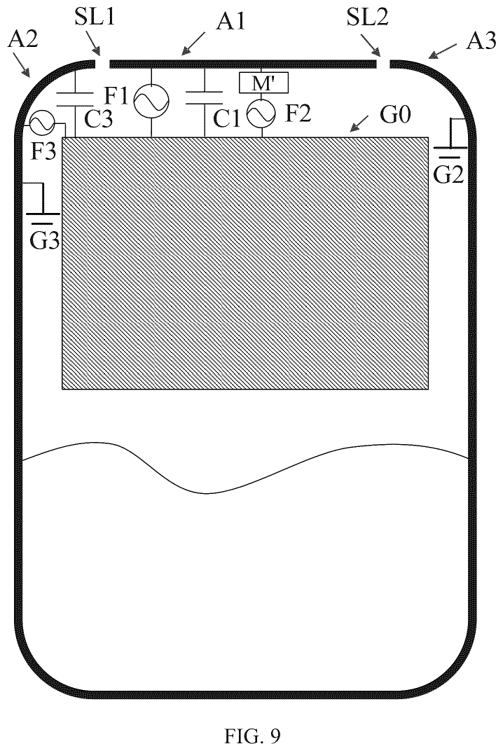

As shown in FIG. 9, the second matching circuit M2 includes a second feed F2 and a matching unit M′.

One end of the matching unit M′ is connected to the second position, the other end of the matching unit M′ is connected to one end of the second feed F2, and the other end of the second feed F2 is grounded.

The matching unit M′ includes the second capacitor C2 connected in parallel with the second feed F2.

In an implementation, as shown in FIG. 9, the second matching circuit M2 may include the second feed F2 and the matching unit M′ connected in series. In some embodiments, the matching unit M′ is disposed between the second position of the antenna radiation body A1 and the second feed F2, and the second feed F2 is disposed between the matching unit M′ and the ground plane. In other words, one end of the matching unit M′ is connected to the second position, the other end of the matching unit M′ is connected to one end of the second feed F2, and the other end of the second feed F2 is grounded, for example, connected to the main ground G0.

In this implementation, a parallel capacitor configuration needs to be used at one end of the matching unit M′ close to the antenna radiation body A1. To be specific, the second capacitor C2 is located at the end of the matching unit M′ close to the antenna radiation body A1, and is connected in parallel with the second feed F2. The parallel capacitor, that is, the second capacitor C2, has a smaller capacitor value than the first capacitor C1, for example, 3 pf.

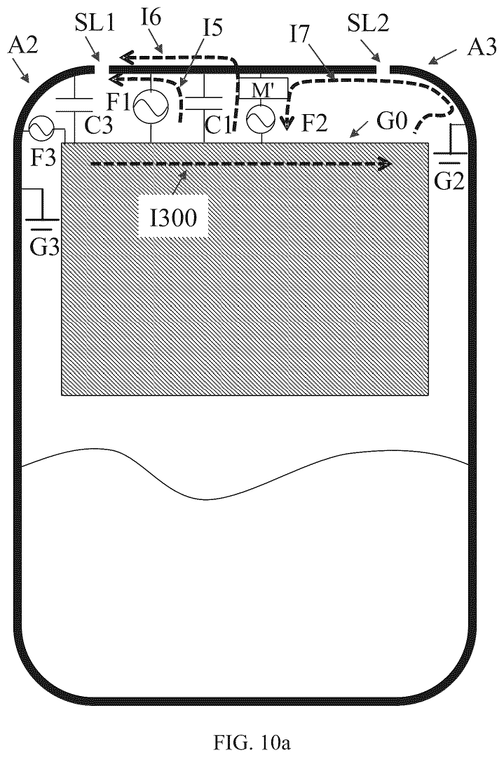

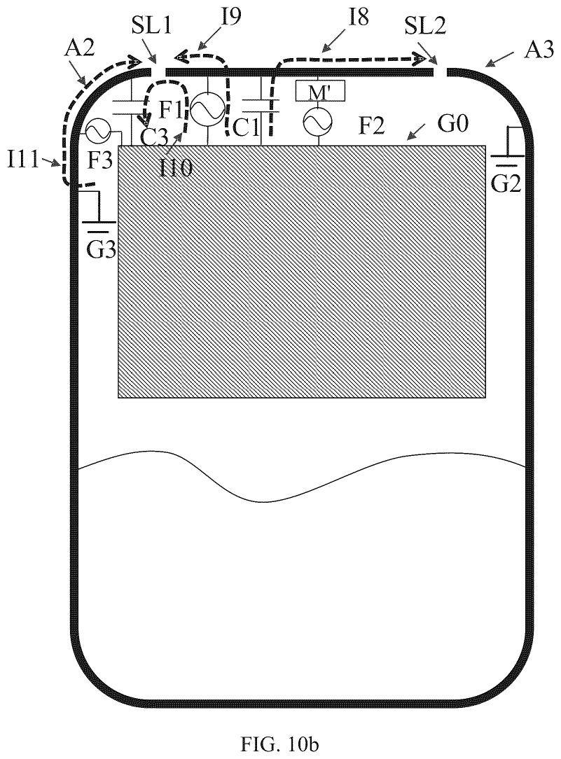

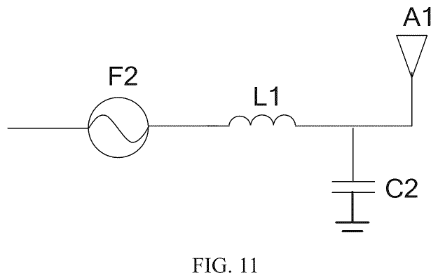

The antenna structure 100 in this implementation may still maintain three operating modes. As shown in FIG. 10a, 15 is an IFA ¼ wavelength mode from SL1 to the near-feed ground capacitor C1, 16 is a loaded IFA ¼ wavelength mode from SL1 to the parallel capacitor C2 in the matching unit M′, and I7 is a gap co-directional current mode from G2 through SL2 to the parallel capacitor C2 in the matching unit M′. The three operating modes jointly improve a radiation capability of the GPS antenna. In addition, an operating mode of a low frequency band may be further implemented through the second feed F2, and through the first feed F1 supporting functions of a GPS L1 band and a WIFI 2.4G band. As shown in FIG. 10b, 18 is the operating mode of the low frequency band, that is, an IFA ¼ wavelength mode from C1 to SL2, and 19 is an operating mode of the newly added WIFI 2.4G band, that is, a monopole ¼ wavelength mode from F1 to SL1.

In this way, in this implementation, the three basic operating modes of the GPS antenna can be implemented, and operating modes of the low frequency band and the WIFI 2.4G band can be implemented, thereby further improving radiation performance of the antenna.

As shown in FIG. 11, the matching unit M′ includes a first inductor L1 and the second capacitor C2.

One end of the first inductor L1 is connected to the second position, the other end of the first inductor L1 is connected to one end of the second feed F2, and the other end of the second feed F2 is grounded.

One end of the second capacitor C2 is connected to the second position, and the other end of the second capacitor C2 is grounded.

In an implementation, a typical matching circuit structure shown in FIG. 11 may be used, which uses a structure in which an inductor is connected in parallel to a capacitor. The first inductor L1 is disposed between the second position of the antenna radiation body A1 and the second feed F2, that is, the first inductor L1 is connected in series to the second feed F2, and the second capacitor C2 is disposed between the second position of the antenna radiation body A1 and the ground plane, that is, the second capacitor C2 is connected in parallel to the first inductor L1 and the second feed F2.

In this way, in this implementation, the antenna loaded IFA ¼ wavelength mode can be supported by using the parallel capacitor in the matching circuit, and it is ensured that the antenna structure 100 is simple and easy to implement.

As shown in FIG. 9, the antenna structure 100 further includes a third matching circuit and a third feed F3.

The third matching circuit is disposed between a fourth position of the first coupled radiation branch A2 close to the antenna radiation body A1 and a ground plane.

A fifth position of the first coupled radiation branch A2 away from the antenna radiation body A1 is grounded.

The third feed F3 is disposed between a second feed point on the first coupled radiation branch A2 and a ground plane, where the third matching circuit includes a third capacitor C3, and the second feed point is located between the fourth position and the fifth position.

In an implementation, on the basis of the antenna structure shown in FIG. 9 in which the second matching circuit M2 includes the second feed F2 and the matching unit M′, the antenna structure 100 may further include the third matching circuit and the third feed F3. In some embodiments, the third matching circuit may be disposed between the fourth position of the first coupled radiation branch A2 close to the antenna radiation body A1 and the ground plane. To be specific, one end of the third matching circuit is connected to the fourth position of the first coupled radiation branch A2 close to the antenna radiation body A1, and the other end of the third matching circuit is grounded, for example, connected to main ground G0. The third feed F3 is disposed between the second feed point on the first coupled radiation branch A2 and the ground plane. To be specific, one end of the third feed F3 is connected to the second feed point on the first coupled radiation branch A2, and the other end of the third feed F3 is grounded, for example, connected to the main ground G0. The fifth position of the first coupled radiation branch A2 away from the antenna radiation body A1 is grounded, for example, the fifth position of the first coupled radiation branch A2 may be connected to a ground point G3. The second feed point is located between the fourth position and the fifth position.

In this implementation, the third matching circuit includes a third capacitor C3. In some embodiments, the third matching circuit may further include another component, such as a capacitor or a resistor, or the third matching circuit may include only the third capacitor C3. The third capacitor C3 is a high-frequency current-through capacitor connected to ground on the first coupled radiation branch A2.

In this implementation, the first feed F1 may support function implementation of a GPS L1 band, a WIFI 2.4G band, and a WIFI 5G band. As shown in FIGS. 10a, I5, I6, and I7 are three operating modes of the GPS L1 band, and I300 is a schematic range of top transverse currents excited by the three operating modes, which can significantly improve a radiation proportion of an upper hemisphere of the GPS antenna. As shown in FIG. 10b, 19 is an operating mode of the newly added WIFI 2.4G band, that is, a monopole ¼ wavelength mode from F1 to SL1, and I10 is an operating mode of the newly added WIFI 5G band, that is, a gap co-directional current mode from F1 to the ground C3. The third feed F3 can implement performance of the GPS L5 band. As shown in FIG. 10b, an operating mode I11 of the third feed F3 is an IFA ¼ wavelength mode from G3 to SL1.

In this way, in this implementation, the WIFI 2.4G/5G band may be integrated in the antenna structure 100, and a dual-band GPS may be implemented in the antenna structure 100, thereby further enriching operating modes and improving radiation performance of the antenna.

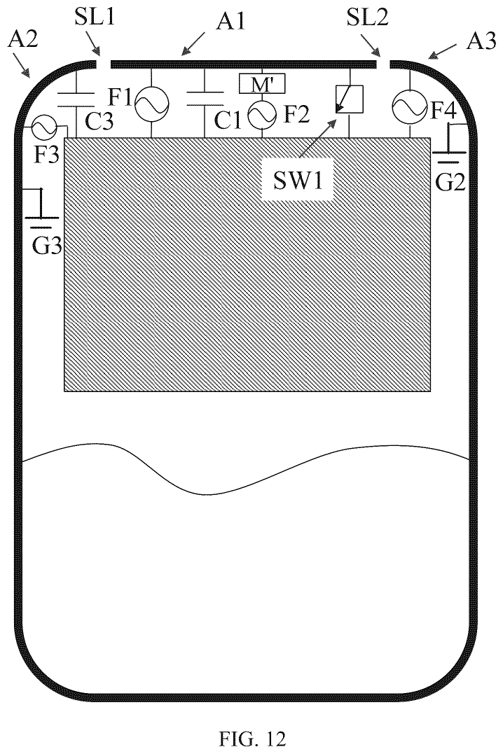

As shown in FIG. 12, the antenna structure 100 further includes a fourth feed F4 and a parasitic branch switch circuit.

The fourth feed F4 is disposed between a third feed point that is on the second coupled radiation branch A3 and that is close to the antenna radiation body A1 and a ground plane.

The parasitic branch switch circuit is disposed between a sixth position of the antenna radiation body A1 close to the second coupled radiation branch A3 and a ground plane.

The parasitic branch switch circuit includes a switching switch SW1 and a plurality of resonant branches, and the switching switch SW1 is configured to switch to different resonant branches, so as to switch to different antenna operating bands.

In an implementation, on the basis of the antenna structure shown in FIG. 9, the fourth feed F4 and the parasitic branch switch circuit may be added. The fourth feed F4 is configured to implement an operating mode of an antenna in a middle-high band for Long Term Evolution (LTE) and New Radio (NR), and the parasitic branch switch circuit is configured to tune a frequency band.

As shown in FIG. 12, the fourth feed F4 is disposed between the third feed point that is on the second coupled radiation branch A3 and that is close to the antenna radiation body A1 and the ground plane. To be specific, one end of the fourth feed F4 is connected to the third feed point that is on the second coupled radiation branch A3 and that is close to the antenna radiation body A1, and the other end of the fourth feed F4 is grounded, for example, connected to main ground G0. The third position of the second coupled radiation branch A3 away from the antenna radiation body A1 is grounded through a ground point G2. The parasitic branch switch circuit is disposed between the sixth position of the antenna radiation body A1 close to the second coupled radiation branch A3 and the ground plane. To be specific, one end of the parasitic branch switch circuit is connected to the sixth position of the antenna radiation body A1 close to the second coupled radiation branch A3, and the other end of the parasitic branch switch circuit is grounded, for example, connected to the main ground G0.

The parasitic branch switch circuit includes the switching switch SW1 and the plurality of resonant branches, and the switching switch SW1 may be connected to different resonant branches through switching, so as to switch to different antenna operating bands.

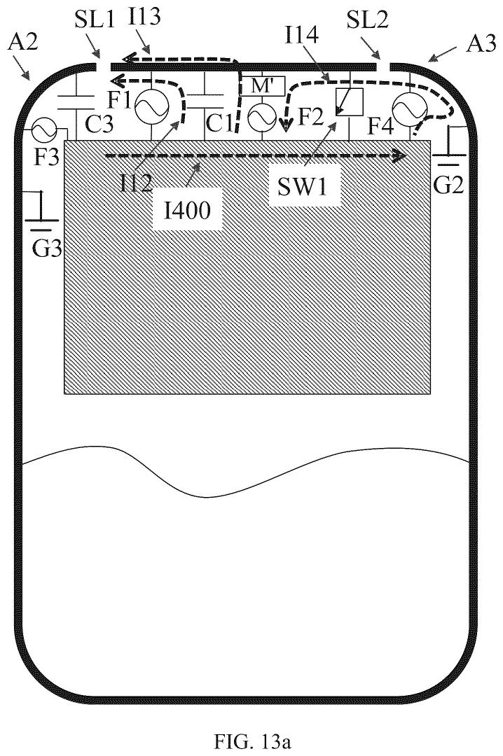

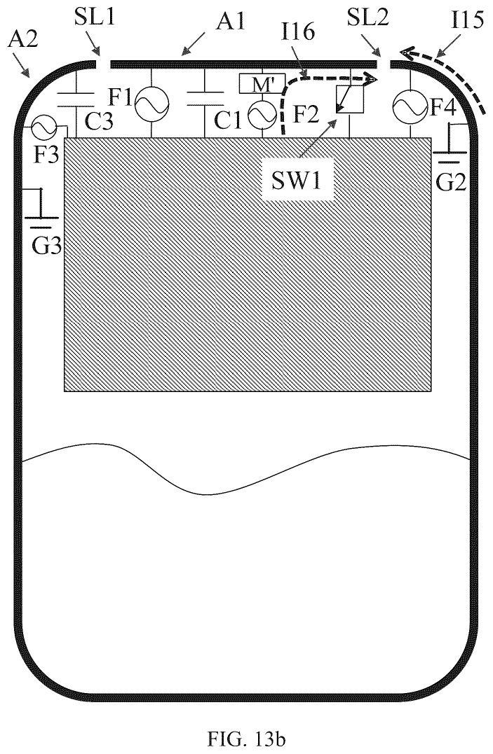

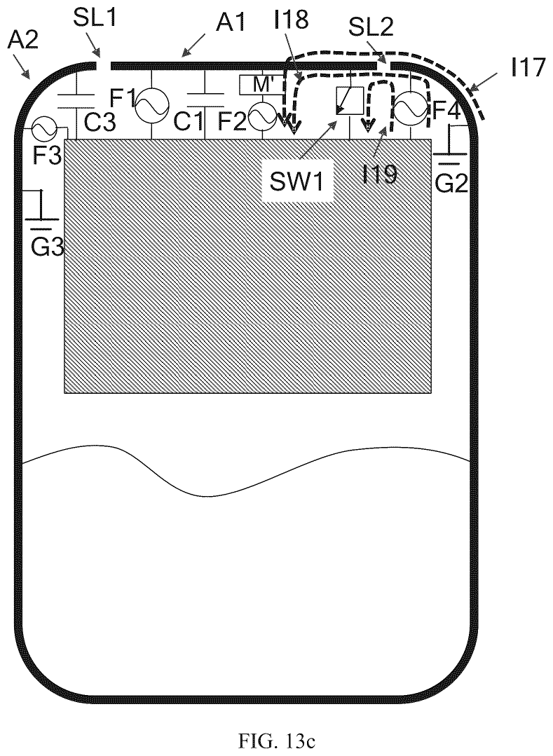

In this implementation, the GPS operating mode of the antenna structure 100 still maintains three operating modes. As shown in FIG. 13a, 112 is an IFA ¼ wavelength mode from SL1 to the near-feed ground capacitor C1, 113 is a loaded IFA ¼ wavelength mode from SL1 to the parallel capacitor C2, and I14 is a gap co-directional current mode from G2 through SL2 to the parallel capacitor C2. The three operating modes jointly improve a radiation capability of the GPS antenna. 1400 is a schematic range of top transverse currents excited by the three operating modes, which can significantly improve a radiation proportion of an upper hemisphere of the GPS antenna.

In addition, the fourth feed F4 and the parasitic branch switch circuit may further support a plurality of antenna operating modes. As shown in FIG. 13b and FIG. 13c, antenna operating modes corresponding to the fourth feed F4 include I15, an IFA ¼ wavelength mode from G2 to SL2 (for example, a B32 band), I16, a parasitic ¼ wavelength mode from the parallel capacitor C2 to SL2, 117, a gap co-directional current mode from G2 through SL2 to the ground parallel capacitor C2 (for example, a B3 band), I18, a gap co-directional current mode from F4 through SL2 to the ground parallel capacitor C2 (for example, a B1 band), and I19, a gap co-directional current mode from F4 through SL2 to the ground switching switch SW1 (for example, a B40 band and a B41 band).

In this way, in this implementation, the antenna structure 100 can further support a middle-high band for LTE and NR, thereby further enriching operating modes of the antenna.

In some embodiments, the parasitic branch switch circuit further includes a band-stop LC circuit, and a resonant frequency of the band-stop LC circuit matches an L1 band of a GPS antenna.

One end of the band-stop LC circuit is connected to the sixth position, the other end of the band-stop LC circuit is connected to a non-movable end of the switching switch SW1, and a plurality of movable ends of the switching switch SW1 are respectively connected to the plurality of resonant branches in a one-to-one correspondence.

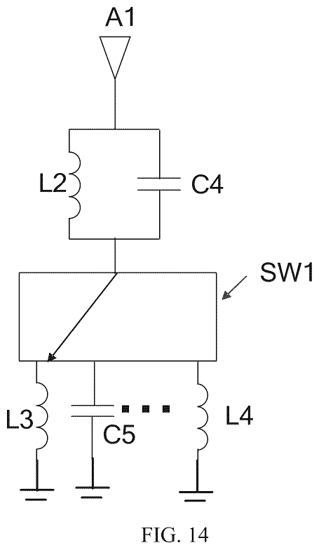

In the antenna structure 100 shown in FIG. 12, it is considered that the operating mode of the GPS antenna is prone to be affected in a switching process of the parasitic branch switch circuit, which causes fluctuations in GPS performance at different middle-high bands. In this implementation, to overcome this problem, the parasitic branch switch circuit may be designed as a circuit structure in FIG. 14. To be specific, a band-stop LC circuit is connected in series at a common end, that is, the non-movable end, of the switching switch SW1, so that a resonant frequency of the band-stop LC circuit is close to the GPS L1 band, thereby providing stable GPS performance.

In this way, in this implementation, it can be ensured that GPS performance is stable in a switching process of the antenna structure 100 among operating modes in a middle-high band.

In some embodiments, any one of the plurality of resonant branches is a capacitor, an inductor, or a capacitor-inductor combination circuit.

In an implementation, switching of the operating modes in a middle-high band of the antenna structure 100 may be implemented by switching the switching switch SW1 to different capacitors, inductors, or combinations thereof. As shown in FIG. 14, each resonant branch connected to each movable end of the switching switch SW1 may be a separate inductor or capacitor, or may be a capacitor-inductor combination.

In this way, the capacitor, the inductor, or the capacitor-inductor combination circuit may be used to generate different resonant frequencies, so that the antenna structure 100 can achieve switching between middle and high bands by switching the switching switch SW1 to different resonant branches, and the circuit structure is simple and easy to implement.

An enhanced GPS antenna structure is designed in the embodiments of this application. The antenna structure may be located at a top of an electronic device. An operating mode of the antenna excites more transverse current modes, thereby improving a proportion of an upper hemisphere in a radiation pattern of the antenna. The antenna structure can integrate WIFI 2.4G/5G, LTE/NR low, middle, and high operating bands, and form a dual-band GPS system with GPS L5. In addition, in a switching process of a Middle High Band (MHB) antenna switch in the antenna structure, stable performance of the GPS antenna can be ensured.

The antenna structure in this embodiment of this application includes an antenna radiation body, a first coupled radiation branch, a second coupled radiation branch, a first feed, a first matching circuit, and a second matching circuit. The antenna radiation body is located between the first coupled radiation branch and the second coupled radiation branch, there is a gap between the antenna radiation body and the first coupled radiation branch, and there is a gap between the antenna radiation body and the second coupled radiation branch. The first feed is disposed between a first feed point on the antenna radiation body and a ground plane. The first matching circuit is disposed between a first position of the antenna radiation body and a ground plane. The second matching circuit is disposed between a second position of the antenna radiation body and a ground plane. A third position of the second coupled radiation branch is grounded. The first matching circuit includes a first capacitor, the second matching circuit includes a second capacitor, a distance between the first position and the first feed point is less than a distance between the second position and the first feed point, and a capacitance value of the first capacitor is greater than a capacitance value of the second capacitor. In this way, a plurality of feed branches are designed in the antenna structure, so that an antenna can form a plurality of current loops to support a plurality of operating modes, and an operating current of the antenna can excite a stronger transverse current, thereby improving radiation performance of the antenna.

An embodiment of this application further provides an electronic device, including the antenna structure according to any one of the foregoing embodiments.

The antenna structure in the embodiments of this application may be applied to antenna system design of electronic devices such as a tablet, a notebook, a base station, a watch, and the like.

The electronic device provided in the embodiments of this application can implement the implementations shown in FIG. 1, FIG. 5, FIG. 9, or FIG. 12, and can achieve a same or similar technical effect. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. An antenna structure, comprising an antenna radiation body, a first coupled radiation branch, a second coupled radiation branch, a first feed, a first matching circuit, and a second matching circuit, wherein:
the antenna radiation body is located between the first coupled radiation branch and the second coupled radiation branch, there is a gap between the antenna radiation body and the first coupled radiation branch, and there is a gap between the antenna radiation body and the second coupled radiation branch;
the first feed is disposed between a first feed point on the antenna radiation body and a ground plane;
the first matching circuit is disposed between a first position of the antenna radiation body and a ground plane;
the second matching circuit is disposed between a second position of the antenna radiation body and a ground plane; and
a third position of the second coupled radiation branch is grounded,
wherein the first matching circuit comprises a first capacitor, the second matching circuit comprises a second capacitor, a distance between the first position and the first feed point is less than a distance between the second position and the first feed point, and a capacitance value of the first capacitor is greater than a capacitance value of the second capacitor.

2. The antenna structure according to claim 1, wherein one end of the first capacitor is connected to the first position, and the other end of the first capacitor is grounded to form the first matching circuit.

3. The antenna structure according to claim 1, wherein one end of the second capacitor is connected to the second position, and the other end of the second capacitor is grounded to form the second matching circuit.

4. The antenna structure according to claim 1, wherein the second matching circuit comprises a second feed and a matching unit;
one end of the matching unit is connected to the second position, the other end of the matching unit is connected to one end of the second feed, and the other end of the second feed is grounded; and
the matching unit comprises the second capacitor connected in parallel with the second feed.

5. The antenna structure according to claim 4, wherein the matching unit comprises a first inductor and the second capacitor;
one end of the first inductor is connected to the second position, the other end of the first inductor is connected to one end of the second feed, and the other end of the second feed is grounded; and
one end of the second capacitor is connected to the second position, and the other end of the second capacitor is grounded.

6. The antenna structure according to claim 4, further comprising a third matching circuit and a third feed, wherein:
the third matching circuit is disposed between a fourth position of the first coupled radiation branch close to the antenna radiation body and a ground plane;
a fifth position of the first coupled radiation branch away from the antenna radiation body is grounded; and
the third feed is disposed between a second feed point on the first coupled radiation branch and a ground plane,
wherein the third matching circuit comprises a third capacitor, and the second feed point is located between the fourth position and the fifth position.

7. The antenna structure according to claim 4, further comprising a fourth feed and a parasitic branch switch circuit, wherein:
the fourth feed is disposed between a third feed point that is on the second coupled radiation branch and that is close to the antenna radiation body and a ground plane;
the parasitic branch switch circuit is disposed between a sixth position of the antenna radiation body close to the second coupled radiation branch and a ground plane; and
the parasitic branch switch circuit comprises a switching switch and a plurality of resonant branches, and the switching switch is configured to switch to different resonant branches, so as to switch to different antenna operating bands.

8. The antenna structure according to claim 7, wherein the parasitic branch switch circuit further comprises a band-stop LC circuit, a resonant frequency of the band-stop LC circuit matches an L1 band of a GPS antenna; and
one end of the band-stop LC circuit is connected to the sixth position, the other end of the band-stop LC circuit is connected to a non-movable end of the switching switch, and a plurality of movable ends of the switching switch are respectively connected to the plurality of resonant branches in a one-to-one correspondence.

9. The antenna structure according to claim 7, wherein any one of the plurality of resonant branches is a capacitor, an inductor, or a capacitor-inductor combination circuit.

10. An electronic device, comprising an antenna structure wherein the antenna structure comprises an antenna radiation body, a first coupled radiation branch, a second coupled radiation branch, a first feed, a first matching circuit, and a second matching circuit, wherein:
the antenna radiation body is located between the first coupled radiation branch and the second coupled radiation branch, there is a gap between the antenna radiation body and the first coupled radiation branch, and there is a gap between the antenna radiation body and the second coupled radiation branch;
the first feed is disposed between a first feed point on the antenna radiation body and a ground plane;
the first matching circuit is disposed between a first position of the antenna radiation body and a ground plane;
the second matching circuit is disposed between a second position of the antenna radiation body and a ground plane; and
a third position of the second coupled radiation branch is grounded,
wherein the first matching circuit comprises a first capacitor, the second matching circuit comprises a second capacitor, a distance between the first position and the first feed point is less than a distance between the second position and the first feed point, and a capacitance value of the first capacitor is greater than a capacitance value of the second capacitor.

11. The electronic device according to claim 10, wherein one end of the first capacitor is connected to the first position, and the other end of the first capacitor is grounded to form the first matching circuit.

12. The electronic device according to claim 10, wherein one end of the second capacitor is connected to the second position, and the other end of the second capacitor is grounded to form the second matching circuit.

13. The electronic device according to claim 10, wherein the second matching circuit comprises a second feed and a matching unit;
one end of the matching unit is connected to the second position, the other end of the matching unit is connected to one end of the second feed, and the other end of the second feed is grounded; and
the matching unit comprises the second capacitor connected in parallel with the second feed.

14. The electronic device according to claim 13, wherein the matching unit comprises a first inductor and the second capacitor;
one end of the first inductor is connected to the second position, the other end of the first inductor is connected to one end of the second feed, and the other end of the second feed is grounded; and
one end of the second capacitor is connected to the second position, and the other end of the second capacitor is grounded.

15. The electronic device according to claim 13, wherein the antenna structure further comprises a third matching circuit and a third feed, wherein:
the third matching circuit is disposed between a fourth position of the first coupled radiation branch close to the antenna radiation body and a ground plane;
a fifth position of the first coupled radiation branch away from the antenna radiation body is grounded; and
the third feed is disposed between a second feed point on the first coupled radiation branch and a ground plane,
wherein the third matching circuit comprises a third capacitor, and the second feed point is located between the fourth position and the fifth position.

16. The electronic device according to claim 13, wherein the antenna structure further comprises a fourth feed and a parasitic branch switch circuit, wherein:
the fourth feed is disposed between a third feed point that is on the second coupled radiation branch and that is close to the antenna radiation body and a ground plane;
the parasitic branch switch circuit is disposed between a sixth position of the antenna radiation body close to the second coupled radiation branch and a ground plane; and
the parasitic branch switch circuit comprises a switching switch and a plurality of resonant branches, and the switching switch is configured to switch to different resonant branches, so as to switch to different antenna operating bands.

17. The electronic device according to claim 16, wherein the parasitic branch switch circuit further comprises a band-stop LC circuit, a resonant frequency of the band-stop LC circuit matches an L1 band of a GPS antenna; and
one end of the band-stop LC circuit is connected to the sixth position, the other end of the band-stop LC circuit is connected to a non-movable end of the switching switch, and a plurality of movable ends of the switching switch are respectively connected to the plurality of resonant branches in a one-to-one correspondence.

18. The electronic device according to claim 16, wherein any one of the plurality of resonant branches is a capacitor, an inductor, or a capacitor-inductor combination circuit.
